(19) United States
(12) Patent Application Publication
(10) Pub. No.: US 2008/0245242 A1
(43) Pub. Date: Oct. 9, 2008

(54) Compact kitchen device

(76) Inventor: Douglas Birdsall, Riverside, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/784,610

(22) Filed: Apr. 9, 2007

(51) Int. Cl. A47J 43/04

(52) U.S. Cl. 99/449

(57) ABSTRACT

A compact kitchen device having a one-piece housing shell that has a rear wall, a plurality of side walls, a plurality of front walls, and a base. The housing shell has a depth and a width so that the housing shell is deliverable through a standard doorway. The housing shell has an interior volume that has a refrigerator, a sink, a microwave oven, a stove top burner, and a plurality of storage areas. The kitchen device has a plumbing conduit that is releasably connected to an external hot and cold water supply, a waste conduit that is releasably connected to an external vented sewage line, and an electrical circuit that is releasably connected to an external power source.

### BACKGROUND OF THE INVENTION

1. Field of the Invention

The present disclosure relates to a kitchen device. More specifically, the present disclosure relates to a compact, full-service kitchen device that can easily be transported through a standard doorway.

2. Description of Related Art

A traditional kitchen has appliances such as a refrigerator, a freezer, a microwave oven, a stove, a sink, and, perhaps, a toaster. Traditional kitchens may also have a garbage receptacle, a trash compactor, a countertop, and a plurality of storage areas. Most of these appliances are cumbersome and awkwardly shaped such that they occupy large amounts of space. Thus, many areas where kitchen capabilities are often desired, such as offices, shops, break rooms, dormitories, hotel rooms, studio apartments, basements and other areas with limited space, lack any level of kitchen functionality.

Some of the aforementioned areas may have several small kitchen appliances such as a miniature refrigerator or a microwave oven but ordinarily, a complete range of kitchen functionalities are lacking. When limited kitchen capabilities are provided, the overall culinary experience is diminished. Even if one of the areas that often lack kitchen functionalities possessed the requisite space to provide a full-service kitchen, the appliances must be purchased, installed and configured individually. Thus, it is impractical to build any resemblance of a fully operational kitchen in such an area. Further, space constraints frequently prevent a full range of kitchen capabilities from being installed in their preferred location.

The shape and size of traditional kitchen appliances makes the task of transporting the appliances from one location to another quite laborious. The lack of portability of traditional kitchen appliances discourages offices, hotels, dormitories and other unconventional kitchen settings from installing kitchen appliances or full kitchen units. If these areas were offered a compact, full-service kitchen device that could easily be transported through a standard doorway, and that was either partially or fully enclosed such that any activity therein did not disturb the aesthetics of the surrounding areas, the demand to provide such facilities would increase.

Accordingly, there is a need for a compact, full-service kitchen device that is easy to operate, readily transportable, and provides a full range of kitchen functionalities. A kitchen device is needed that provides an enjoyable culinary experience in unconventional kitchen settings, while affording a user the optimal kitchen solution. There is a further need for a kitchen device that integrates multiple kitchen appliances into a stand-alone, self-contained device that can easily be delivered through a standard doorway, and that maximizes the usefulness of available space.

### SUMMARY OF THE INVENTION

The present disclosure provides a compact, full-service kitchen device that offers a full range of kitchen functionalities.

The present disclosure also provides a kitchen device that has a size and shape such that it is lightweight and can be readily transported and delivered through a standard doorway without any modifications to the device or the doorway through which it is passing.

The present disclosure further provides a kitchen device that maximizes the usefulness of available space by efficiently designing the exterior shell of the device, the interior cabinetry, the countertops and the layout of the kitchen appliances.

The present disclosure still further provides such a device that has a plumbing conduit that is releasably connected to an external hot and cold water supply, a waste conduit that is releasably connected to an external vented sewage line, and an electrical circuit that is releasably connected to an external power source.

The present disclosure yet further provides such a device that comes to the consumer fully assembled and ready to use after making the aforementioned connections.

The present disclosure also provides a kitchen device that offers a full range of kitchen functionalities, can be readily transported and delivered through a standard doorway, and provides a pleasing aesthetic appearance in which in an exemplary embodiment, appliances are positioned out-of-view so that the device appears as an aesthetic addition to a conventional room.

These and other advantages and benefits of the present disclosure are provided by a kitchen device having an exterior housing shell that has a rear wall, a plurality of side walls, a plurality of front walls, and a base. The housing shell has a depth and width such that it is deliverable through a standard doorway. The kitchen device has an interior volume that is encapsulated by the exterior housing shell. The interior volume has a refrigerator, a sink, a microwave oven, a stove top burner and a plurality of storage areas. The kitchen device has a plumbing conduit that is releasably connected to an external hot and cold water supply, a waste conduit that is releasably connected to an external vented sewage line, and an electrical circuit that is releasably connected to an external power source.

The kitchen device can have optional appliances including a convection oven, a dishwasher, a coffee pot, a toaster, a freezer, a blender, a food processor, and any other kitchen functionality conveniences. The device may also have a ventilation system that circulates air and purges gas and/or smoke that is produced in the kitchen device.

In an exemplary embodiment, the external housing shell of the kitchen device can also have one or more doors such that the interior of the housing is enclosed, although the door(s) may be easily opened to provide access to the device. In an exemplary embodiment, the kitchen device can have an overhead enclosure that is releasably fastened to one of the side walls so that it may be opened, thereby exposing the interior volume of the device to the surrounding overhead environment.

In another aspect, a method of providing full-service kitchen capabilities in a compact kitchen device is provided. The method includes providing a kitchen device with a refrigerator, a sink, a microwave oven, a stove top burner and a plurality of storage areas. The kitchen device may be enclosed and self-contained. The method comprises moving the kitchen device through a door frame into a room. Then, connecting in any order, the plumbing conduit to an external hot and cold water supply, the waste conduit to an external vented sewage line, and the electrical circuit to an external power source.

The above-described and other features and advantages of the present disclosure will be appreciated and understood by those skilled in the art from the following detailed description, drawings, and appended claims.

### DESCRIPTION OF THE SEVERAL VIEWS OF THE DRAWINGS

FIG. 1 is a first three-dimensional view of an exemplary embodiment of the compact kitchen device of the present disclosure.

FIG. 2 is a second three-dimensional view of the exemplary embodiment of the compact kitchen device of FIG. 1 turned ninety degrees.

FIG. 3 is a top view of the compact kitchen device of FIG. 1.

FIG. 4 is a top cross-sectional view of the compact kitchen device of FIG. 1.

FIG. 5 is a bottom view of the compact kitchen device of FIG. 1.

FIG. 6 is a side view of the compact kitchen device of FIG. 1.

FIG. 7 is a front cross-sectional view of the compact kitchen device of FIG. 1.

FIG. 8 is a side cross-sectional view of the compact kitchen device of FIG. 1.

FIG. 9 is a three-dimensional view of the connections to the external hot and cold water supply, the external vented sewage line, and the external power source of the compact kitchen device of FIG. 1.

FIG. 10 is a three-dimensional view of a second exemplary embodiment of the compact kitchen device of the present disclosure where the front walls are removed therefrom.

FIG. 11 is a three-dimensional view of a third exemplary embodiment of the compact kitchen device of the present disclosure with one or more doors installed thereon.

FIG. 12 is a three-dimensional view of a fourth exemplary embodiment of the compact kitchen device of the present disclosure with an overhead enclosure installed thereon.

FIG. 13 is a three-dimensional view of a fifth exemplary embodiment of the compact kitchen device of the present disclosure with an overhead enclosure installed thereon and where the front walls are removed therefrom.

FIG. 14 is a three-dimensional view of a sixth exemplary embodiment of the compact kitchen device of the present disclosure with an overhead enclosure and one or more doors installed thereon.

### DETAILED DESCRIPTION OF THE INVENTION

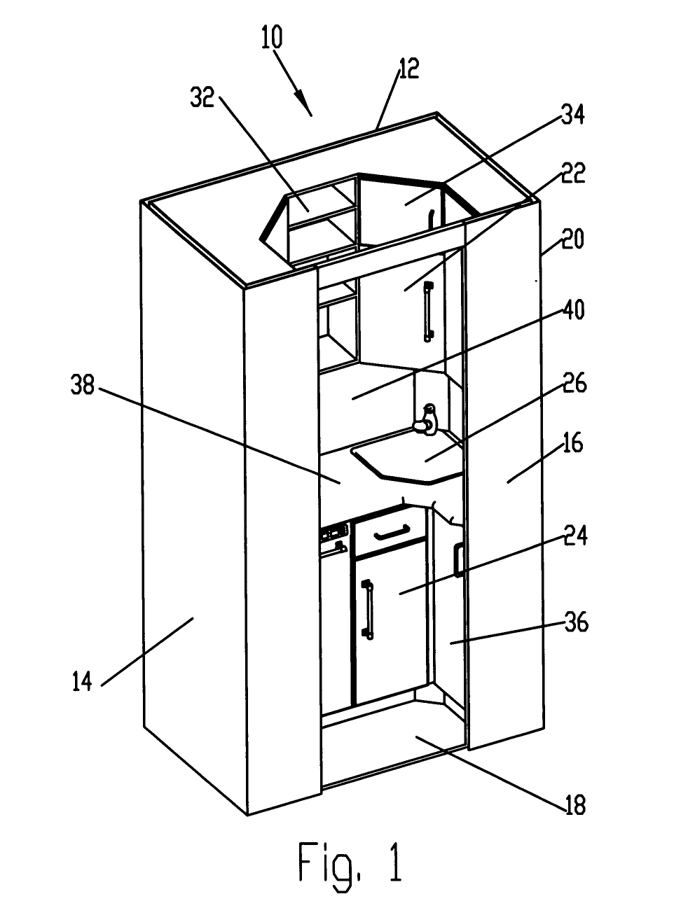

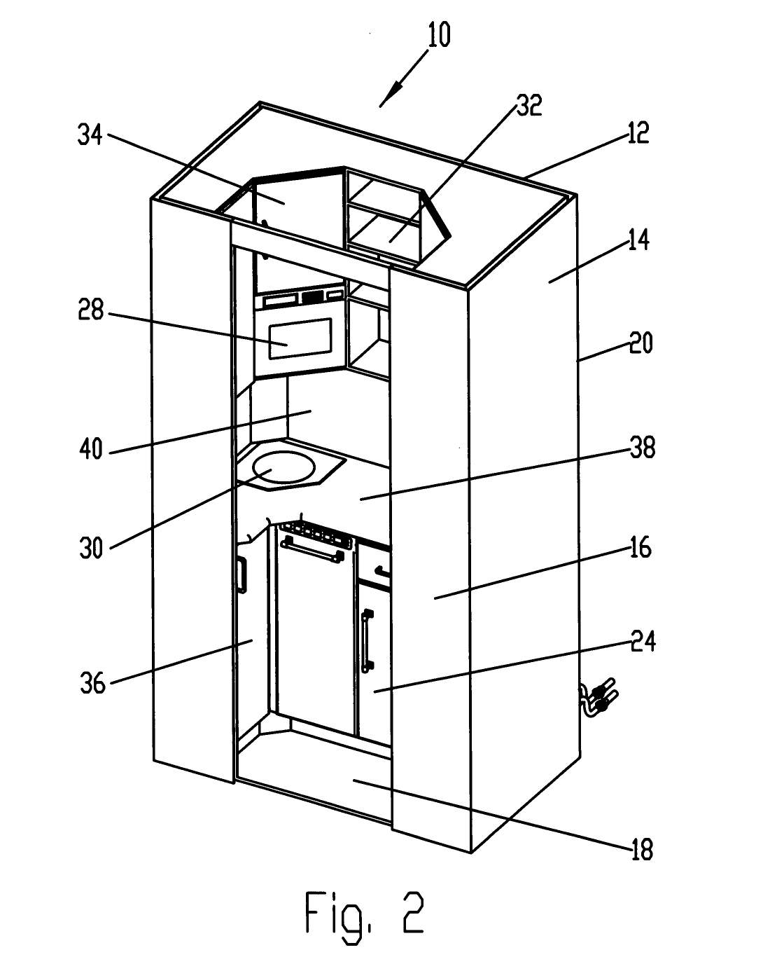

Referring to the drawings and, in particular, FIGS. 1 and 2, a compact, full-service kitchen device is shown and generally represented by reference number 10. In an exemplary embodiment, kitchen device 10 has a rear wall 12, a plurality of outer side walls 14, a plurality of front walls 16, and a base 18. The rear wall 12, the side walls 14, the front walls 16, and the base 18 make up a one-piece exterior housing shell 20 of the kitchen device. The housing shell 20 has exterior depth and width dimensions such that kitchen device 10 is deliverable through a standard 30″ doorway of a room. The room may be in any building such as a house, office, break room, dormitory, hotel, apartment, basement, school, store, or any other residential, commercial, industrial or institutional building where the kitchen device 10 is provided.

In the exemplary embodiment, the interior volume of kitchen device 10 has an overhead and/or a lower refrigerator, 22 and 24 respectively, a sink 26, a microwave oven 28, and a stove top burner 30. Additionally, it is contemplated by the present disclosure that kitchen device 10 can include optional features and appliances including a convection oven, a garbage receptacle, a dishwasher, a coffee pot, a toaster, a freezer, a blender, a food processor, and any other cooking and kitchen functionality conveniences.

Advantageously, kitchen device 10 is configured to provide a maximum number of storage areas. In the exemplary embodiment, kitchen device 10 has a plurality of shelves 32, a plurality of overhead cabinets 34 located at or above eye level that can be easily opened/closed without bending or reaching, and a plurality of lower cabinets 36 that are installed beneath a countertop 38. The countertop 38 extends along an inner wall 40 of the interior volume of the kitchen device 10. The countertop 38 is shaped with smoothed or bent edges that maximize the usefulness of available space and provide optimal preparation and cooking conditions.

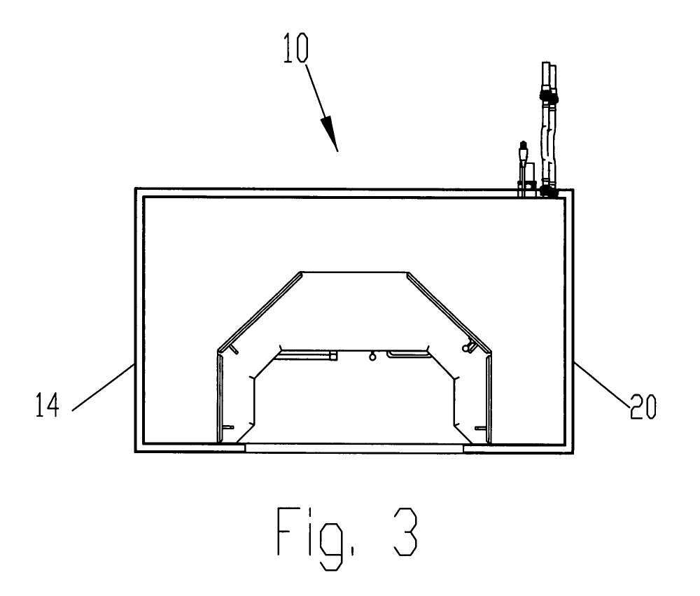

Referring now to FIGS. 3 through 6, the outer side walls 14 of the kitchen device 10 form a rectangular shape. In the alternative, the outer side walls 14 may form any other shape. The shape of the outer walls that is chosen should conform to the shape of the room that the kitchen device is to be used such that it provides for abutment of the device against the walls and the corners of a room. For example, the outer walls may form a hexagonal shape that leaves a space behind the device for the connection of a plumbing and waste conduit.

In the exemplary embodiment of kitchen device 10, the front walls 16 extend toward each other such that when the device is viewed straight on, a direct line of sight to the plurality of shelves 32 is provided, absent a view of the appliances therein. The line of sight is unobstructed so that an aesthetically pleasing view of the shelves 32 of the kitchen device 10 is provided.

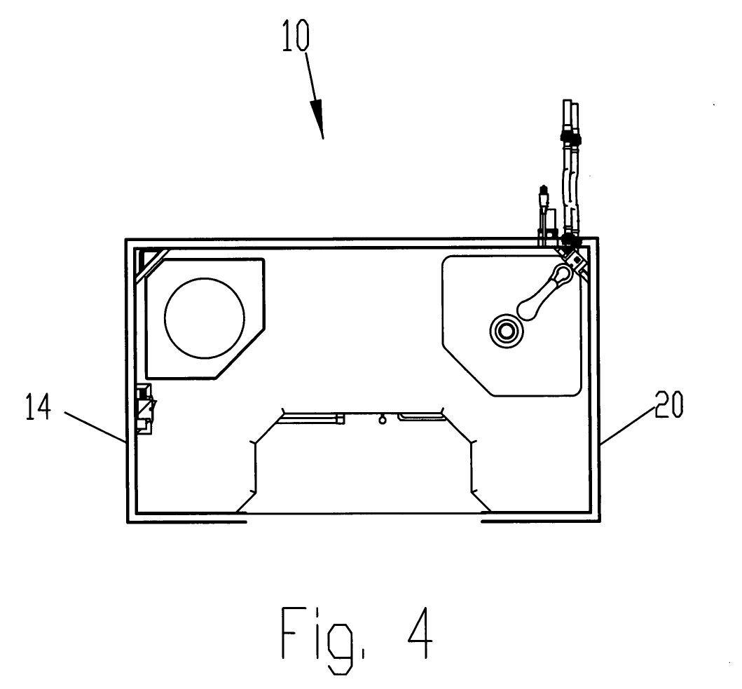

In the exemplary embodiment illustrated in FIGS. 3 and 4, kitchen device 10 has an interior volume that has a trapezoidal-like shape. The interior of the kitchen device 10 has smoothed or bent edges that maximize the usefulness of available space and improve the overall functionality of the device. The overall shape of the interior of kitchen device 10 improves the utility of the device and ensures that a full-service kitchen device is provided to the user. Of course, the present disclosure contemplates any alternative shape being used in the design of the interior volume and the exterior housing shell 20 of the kitchen device 10.

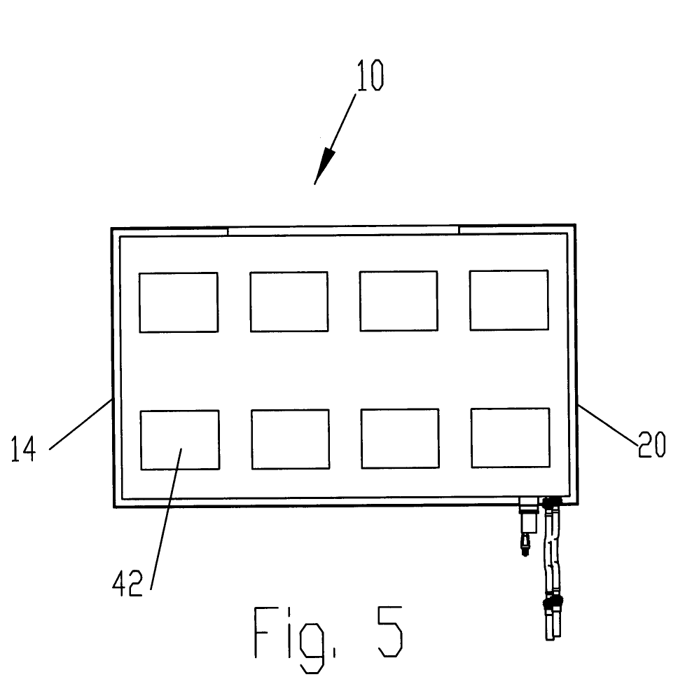

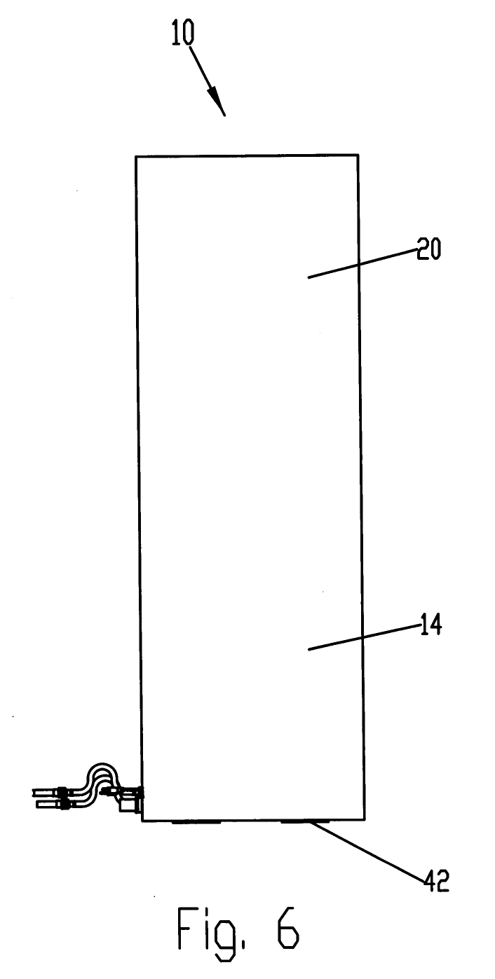

Referring now to FIGS. 5 and 6, an exemplary embodiment of the kitchen device 10 has a plurality of adjustable feet 42 attached to the base 16 that enable the device to be pitched, or leveled. Adjustable feet 42 may also have removable wheels affixed thereon that facilitate transportation of the kitchen device 10 through a standard door frame.

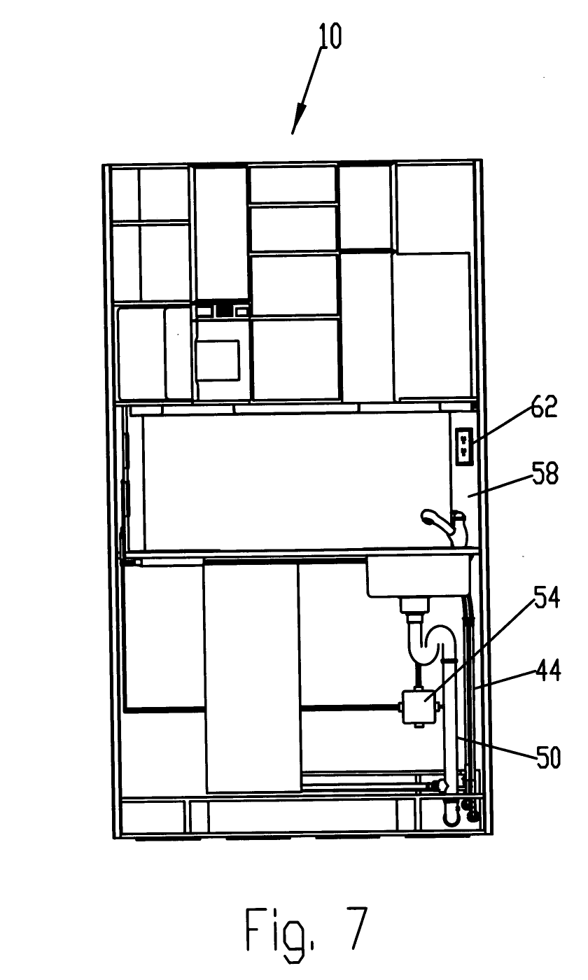

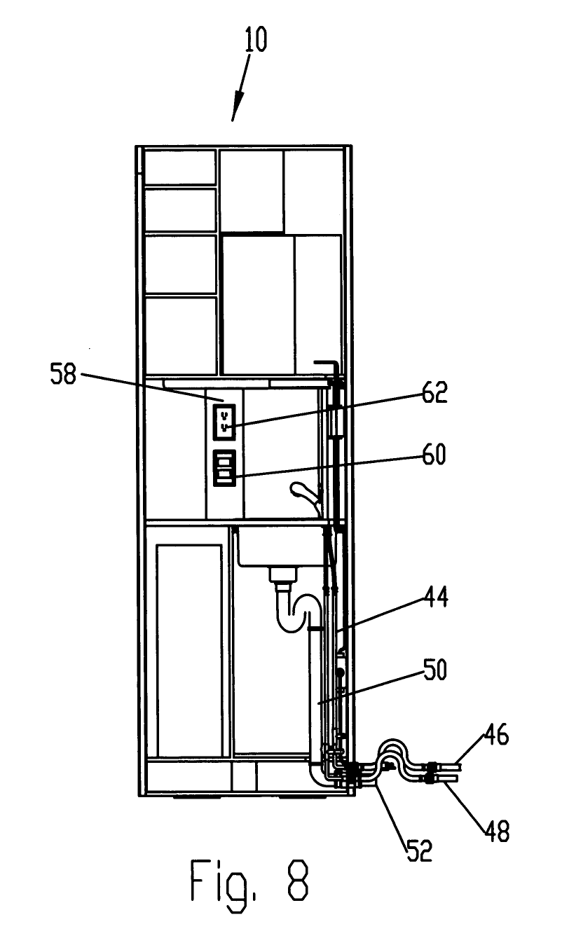

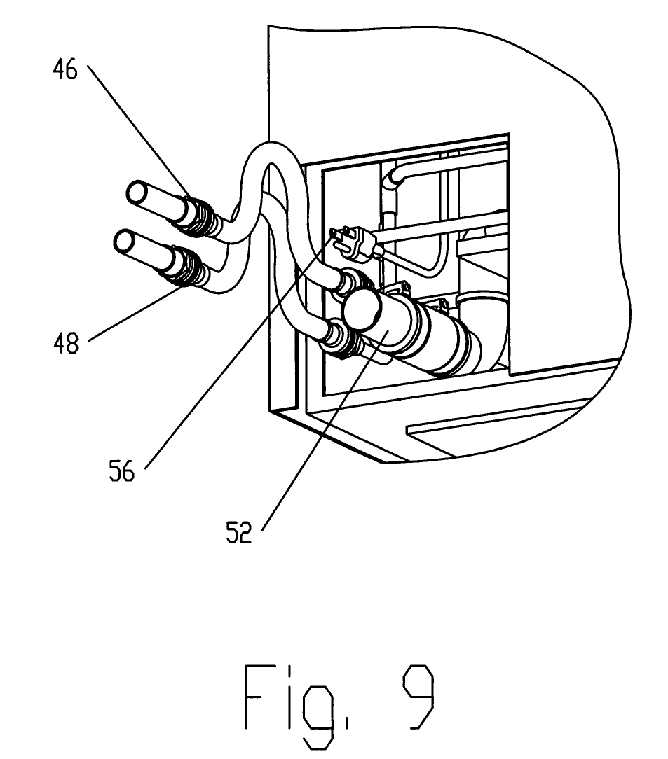

In FIGS. 7 through 9, an exemplary embodiment of kitchen device 10 illustrates a plumbing conduit and a waste conduit that make it fully operational. First, the device has a plumbing conduit 44 that is releasably connected to an external hot and cold water supply, 46 and 48 respectively. Second, the device has a waste conduit 50 that is releasably connected to an external vented sewage line 52. The waste conduit 50 is used to export sewage that is generated by the device 10. In an exemplary embodiment, the waste can flow freely, by gravity, or a macerator can pump the waste if it is installed below the sewage exit level.

FIGS. 7 through 9 also illustrate an electrical circuit 54 of the kitchen device 10 that is releasably connected to an external power source 56 that provides light and power to the device. In the exemplary embodiment, the power source is 110 v/120 v. However, the power source may be any other voltage such as 220 v/240 v or 12 v. One or more corner power strips 58 are installed in the kitchen device 10 that contain a switch box 60 and an outlet box 62 so that the appliances have access to the power source.

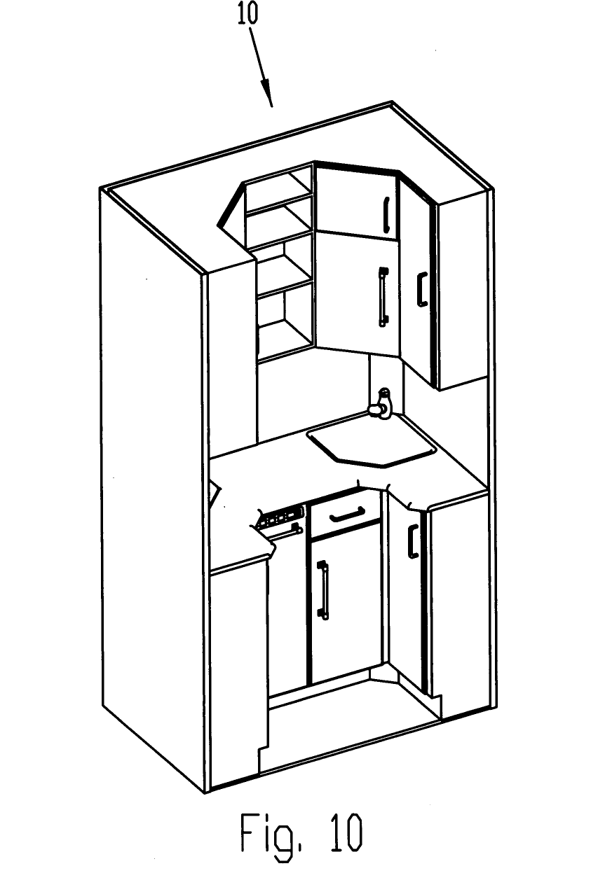

Referring now to FIG. 10, a second exemplary embodiment of the kitchen device 10 is illustrated where the device does not have front walls so that all of the interior of the device can be seen.

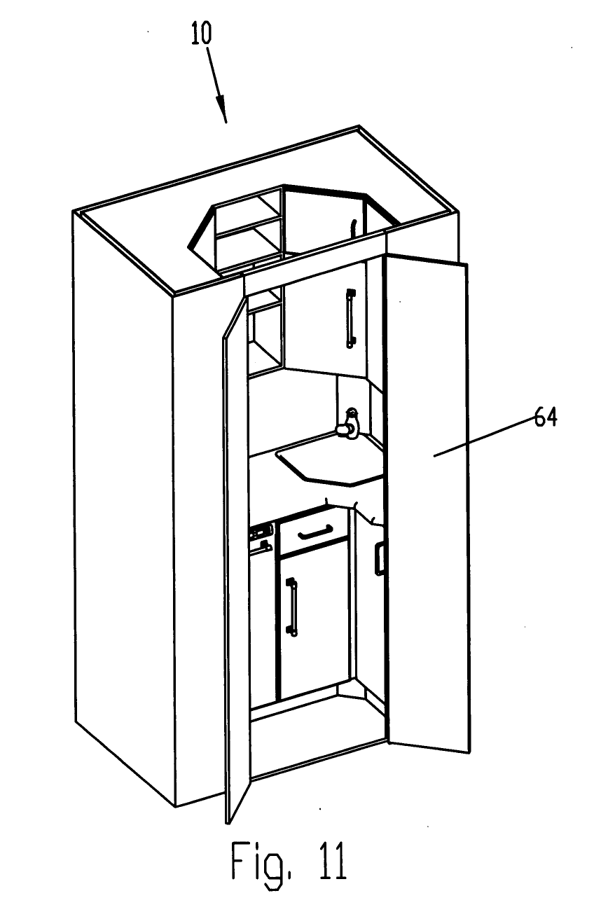

FIG. 11 illustrates a third exemplary embodiment of the kitchen device 10 where the device has one or more doors 64 installed thereon such that it resembles a closed furniture-like device. The door(s) 64 open and close to provide access from the room where the kitchen device 10 is located. The door(s) 64 may be a set of double doors that open inward or outward, a set of double doors that slide outward (not shown), a single door that swings inward or outward (not shown), or a sliding door that opens laterally (not shown). Of course, the present disclosure contemplates any alternative door configuration to be used in the design of the kitchen device 10.

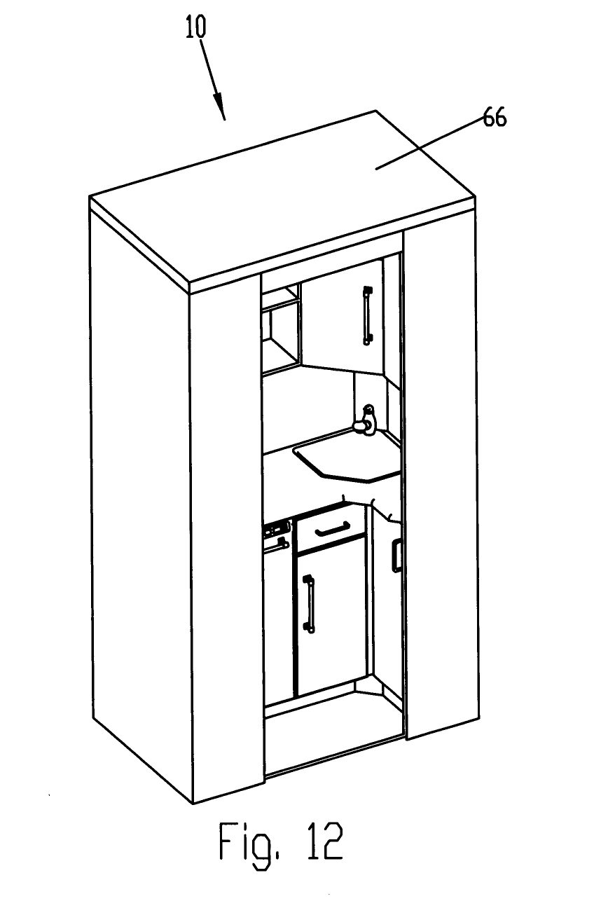

FIG. 12 is a three-dimensional view of the fourth exemplary embodiment of the kitchen device 10 with an overhead enclosure 66 installed thereon. The overhead enclosure 66 is releasably fastened to one of the outer side walls 14 such that it may be opened and closed easily. Alternatively, overhead enclosure 66 can be entirely removed from kitchen device 10 so that the kitchen device 10 is open on top. In the exemplary embodiment with an overhead enclosure 66 installed, kitchen device 10 can have a ventilation system that circulates air and purges gas and/or smoke that is produced in the device.

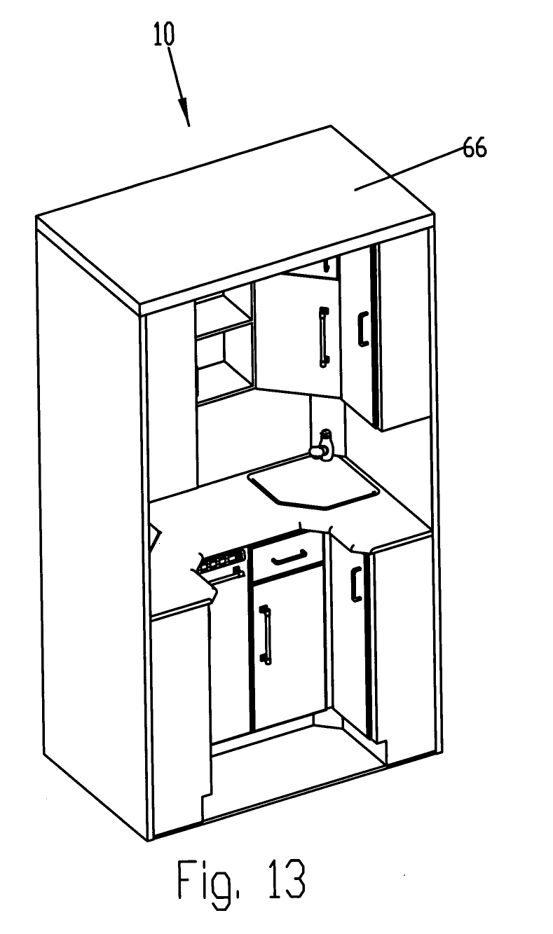

FIG. 13 illustrates a fifth exemplary embodiment of the kitchen device 10 that has an overhead enclosure 66 installed thereon and where the front walls of the device are removed therefrom so that all of the interior of the device can be seen.

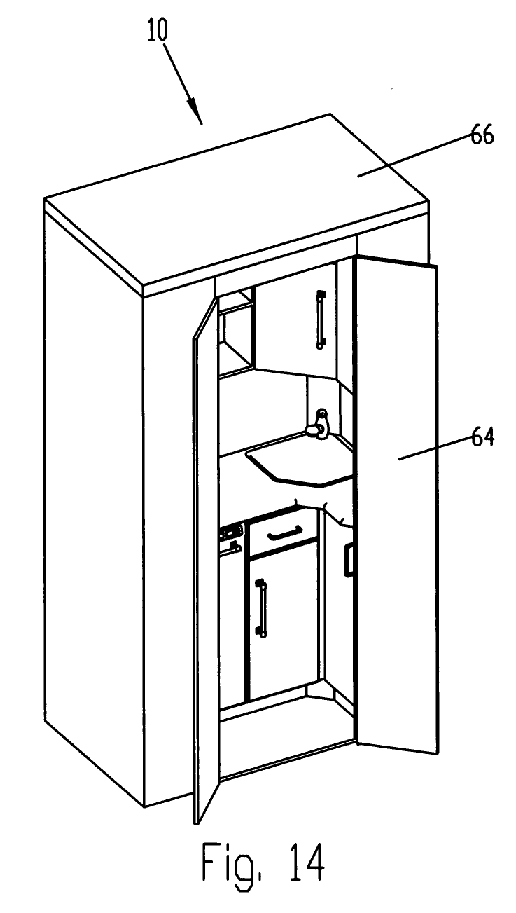

FIG. 14 illustrates a sixth exemplary embodiment of the kitchen device 10 that has an overhead enclosure 66 and one or more doors 64 installed thereon.

The kitchen device 10 may come in a variety of sizes. A small unit is designed to fit through a 30″ doorway without any modification to the appliance or the doorway through which it is passing. The small unit has a depth ranging from 26″ to 30″ (preferably 28½), a width ranging from 48″ to 60″ (preferably 48″), and a height ranging from 80″ to 96″ (preferably 84″). A large unit is designed to fit through a 36″ doorway without any modification to the appliance or the doorway through which it is passing. The large unit has a depth ranging from 32″ to 36″ (preferably 34½), a width ranging from 48″ to 72″ (preferably 60″), and a height ranging from 80″ to 96″ (preferably 84″). Of course, these dimensions can be modified for various geographic regions that have different standard dimensions of door frames.

Each of the aforementioned embodiments and their alternate configurations feature a simple and highly efficient design. The overall profile of kitchen device 10 is minimized, and the dimensions of the design are tailored such that the device is able to fit into a confined space. The edges of the interior walls are smoothed or bent such that optimal preparation and cooking conditions are provided to the user in the space available. The interior and exterior design of the device 10 may be customized to provide an ideal kitchen environment. For example, the door to microwave 28 may be designed to open from the top in a downward direction, such that the door does not block the upper cabinets 34 from opening. Additional custom design features may include hinging the cabinet and appliance doors so that right-handed users may have left-hinged doors while left-handed users may have right-hinged doors.

Kitchen device 10 comes to the user fully assembled and is ready for immediate use after the required connections are made. The device 10 can be designed in different sizes that accommodate delivery through limited size portals. In the exemplary embodiment with one or more doors installed thereon, the door(s) 64 are collapsable such that they may form a table on the front of kitchen device 10 or a bar to the side of the device.

Kitchen device 10, including its support structure and components, is made of strong, durable and lightweight material(s). The interior surfaces of the rear wall 12, the outer side walls 14, the front walls 16, the base 18, the door(s) 64, and the overhead enclosure 66 are made from, or coated with a washable, slick and/or waterproof non-porous material, such as, for example, fiberglass reinforced plastic, and/or high density polyethylene. The exterior surface of housing shell 20 is a finishing material, such as, for example, a laminate, Formica, wood, and/or metal—such as stainless steel or other such material that might be found in furniture, other appliances or room walls. The plumbing and waste conduits throughout kitchen device 10 can be copper, PVC or any other piping material.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A kitchen device for use in a room having a standard doorway comprising:
a one-piece housing shell having a rear wall, a plurality of side walls, a plurality of front walls, and a base, said housing shell having a depth and a width such that said housing shell is deliverable through the standard doorway;
said one-piece housing shell having an interior volume, said interior volume having secured therein a refrigerator, a sink, a microwave oven, a stove top burner, and a plurality of storage areas;
a plumbing conduit that is releasably connected to an external hot and cold water supply;
a waste conduit that is releasably connected to an external vented sewage line; and
an electrical circuit that is releasably connected to an external power source.

2. The kitchen device of claim 1, further comprising one or more kitchen appliances selected from the group consisting essentially of a dishwasher, a coffee pot, a toaster, a freezer, a blender, and a food processor.

3. The kitchen device of claim 1, further comprising one or more doors that open or close to provide access from a room where said kitchen device is located.

4. The kitchen device of claim 3, wherein said one or more doors has a configuration that is selected from the group consisting essentially of a set of double doors that open inward or outward, a set of double doors that slide outward, a single door that swings inward or outward, a sliding door that opens laterally, and any combinations thereof.

5. The kitchen device of claim 1, further comprising an overhead enclosure, wherein said overhead enclosure is releasably fastened to one of said plurality of side walls so that it may be opened and closed easily.

6. The kitchen device of claim 5, wherein said overhead enclosure is releasably fastened to said plurality of side walls so that it may be easily opened, closed or entirely removed.

7. The kitchen device of claim 1, wherein said plurality of front walls are removable.

8. The kitchen device of claim 1, further comprising a ventilation system that circulates air and purges gas and smoke from inside the kitchen device.

9. The kitchen device of claim 1, wherein said one-piece housing shell has a shape that is selected from the group consisting essentially of a rectangle, a square, a hexagon, and any combinations thereof.

10. The kitchen device of claim 1, wherein said interior volume has edges that are smoothed or bent, thereby maximizing the usefulness of available space.

11. The kitchen device of claim 1, wherein said plurality of storage areas are selected from the group consisting essentially of overhead cabinets, lower cabinets, drawers, shelves, and any combinations thereof.

12. The kitchen device of claim 1, further comprising a countertop that extends along said rear and plurality of side walls in said interior volume.

13. The kitchen device of claim 1, further comprising one or more power strips that have a switch box and an outlet box.

14. The kitchen device of claim 1, wherein said one-piece housing shell has a depth that is less than 36″.

15. A method of providing full-service kitchen capabilities in a room, the method comprising:
providing a kitchen device having a refrigerator, a sink, a microwave oven, a stove top burner, and a plurality of storage areas;
moving the kitchen device through a door frame into the room;
connecting the kitchen device to a hot and cold water supply;
connecting the kitchen device to an external vented sewage line; and
connecting the kitchen device to an external power source.

16. The method of claim 15, further comprising providing electrical power to the kitchen device.

17. The method of claim 15, further comprising ventilating an interior of the kitchen device.

18. A kitchen device for use in a room having a standard doorway comprising:
an enclosed exterior housing shell having a rear wall, a plurality of side walls, a plurality of front walls, a base, an overhead enclosure, and one or more openable doors, said housing shell having a depth and a width such that said housing shell is deliverable through the standard doorway; and
an interior volume encapsulated by said housing shell, said interior volume having a refrigerator, a sink, a microwave oven, a stove top burner, and a plurality of storage areas, wherein said one or more openable doors when open provide access to said interior volume.

19. The compact kitchen device of claim 18, further comprising a plumbing conduit that is releasably connected to an external hot and cold water supply, and a waste conduit that is releasably connected to an external hot and cold water supply.

20. The compact kitchen device of claim 18, further comprising an electrical circuit that is releasably connected to an external power source.
